(19) United States
(12) Patent Application Publication
(10) Pub. No.: US 2024/0077047 A1
(43) Pub. Date: Mar. 7, 2024

(54) GEARED TURBOFAN LOW-PRESSURE TURBINE WITH FLAT HUB

(71) Applicant: MTU Aero Engines AG, Muenchen (DE)

(72) Inventors: Jan von Frowein, Dachau (DE); Markus Brettschneider, Karlsfeld (DE); Petra Kufner, Poing (DE); Günter Ramm, Eichenau (DE); Roman Seiband, Todtenweis (DE); Jens Trübenbach, Munich (DE)

(21) Appl. No.: 18/376,602

(22) Filed: Oct. 4, 2023

(51) Int. Cl. F02K 3/06

(52) U.S. Cl. CPC F02K 3/06; F05D 2220/323; F05D 2260/4031

(57) ABSTRACT

A geared turbofan engine includes a plurality of turbine stages, wherein for each stage (i) of the turbine, an inner radius Ri has a maximum deviation between +1.5% and −3% as compared to the average inner radius of the inner blade platforms of the plurality of stages. The engine further includes a fan, the fan coupled to the turbine stages via a gear.

### FIELD OF THE INVENTION

The present invention relates to turbine hubs in a turbine engine.

### BACKGROUND INFORMATION

A turbine engine may include a plurality of turbine stages, with each stage having a plurality of rotor blades (e.g. a rotor blade ring) secured for rotation about a rotor axis by a corresponding plurality of turbine hubs, as well as guide vanes between each stage.

One known type of turbine engine includes a turbine module with rotor blade rings that are coupled to the fan via a gearbox. Such an engine is also referred to as a geared turbofan engine (GTF engine). In operation, the fan rotates at a lower speed than the low-pressure turbine module, translated by the gearbox. In such an engine, the “low-pressure turbine module” refers to that section of the aircraft gas turbine of the turbofan engine that is downstream of a most upstream turbine module, which is directly downstream of the combustion chamber, in the direction of flow. The low pressure turbine module can drive a middle and/or innermost shaft of the turbofan engine.

For aerodynamic reasons, the hub contour in low-pressure turbine modules of conventional geared turbofan (GTF) engines generally has a design that initially rises and then falls as illustrated in prior art FIG. 1. In particular, FIG. 1 illustrates the hub configuration of a conventional four stage geared turbofan (GTF) engine, with the radii of the four stages illustrated. As illustrated, the radius rises between the first and second stages before falling between the second, third and fourth stages.

### SUMMARY OF THE INVENTION

A disadvantage of the prior art design of FIG. 1 is that this hub contour may require comparatively long blade necks (see in particular the third and fourth stages of FIG. 1), which result in increased weight for the engine.

In accordance with an embodiment of the present invention, a geared turbofan engine having a turbine module, in particular a low-pressure turbine (LPT) module for an aircraft engine, is provided which includes a geared turbofan and a flat hub contour. It is to be understood that by geared turbofan it is meant that the fan and the turbine are coupled via a gear. Further, by flat hub contour it is meant that for each stage (i) of the turbine module, the inner radius Rᵢ of the hub has a maximum deviation of +1.5% (to the top) and −3% (to the bottom) as compared to an average of the inner radii of the inner blade platforms of the plurality of stages (e.g. R₁+R₂+R₃+R₄/4 in the case of a four stage LPT module).

In this regard, it is well known that hubs of a turbine themselves may be contoured or flat, and accordingly when we refer to an inner radius Rᵢₙₙₑᵣ (or Rᵢ) of a hub, we mean the average value of the radius of the hub to account for the possibility that the hub is a contoured hub.

TMTF (turning mid-turbine frame, or more generally the Inter-Turbine Duct) and TEC (turbine exhaust case) are not part of the control volume.

A geared turbofan with a flat hub contour as defined above provides the advantage that the corresponding blades (or blade necks) are more uniform and short, thus reducing weight. In addition, the use of essentially uniformly short blade necks allows a reduction in the weight of blade roots and disks because with shorter blade necks the rim load (centrifugal force) is reduced, and the rim load is one of the drivers of the weight of the disk.

### BRIEF DESCRIPTION OF THE DRAWINGS

FIG. 1 schematically illustrates a blade profile of a low pressure turbine module of a geared turbofan engine according to the prior art.

FIG. 2 schematically illustrates a low pressure turbine module of a geared turbofan engine according to an embodiment of the present invention;

FIG. 3 schematically illustrates a geared turbofan engine in accordance with a further embodiment of the present invention.

### DETAILED DESCRIPTION

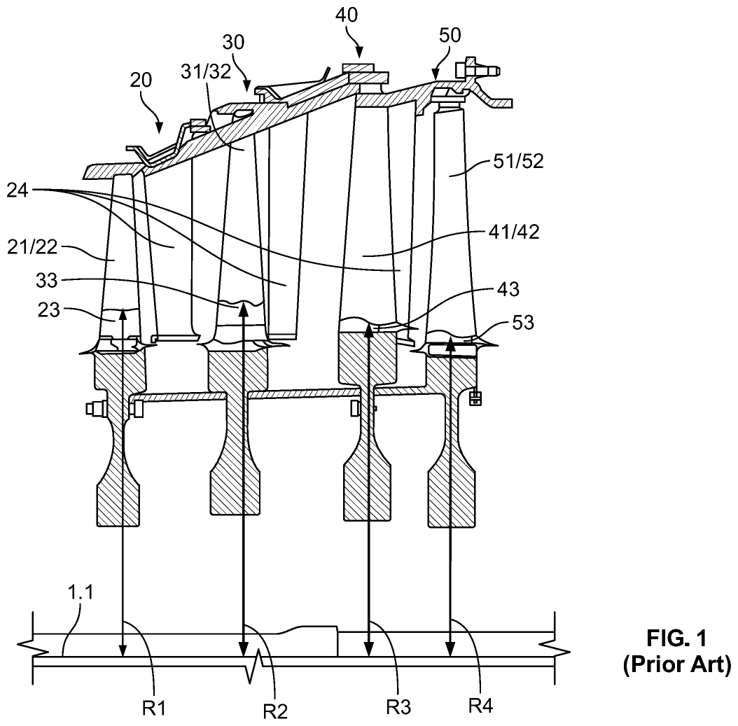

As discussed above, geared turbofan engines conventionally employ a contoured hub profile as illustrated in FIG. 1. FIG. 1 shows a four stage low pressure turbine module of a conventional geared turbofan engine. Illustrated in FIG. 1 are four stages 20, 30, 40, 50 each having a bade ring (21, 31, 41, 51). Each blade ring includes a plurality of blades mounted on respective hubs. One of the plurality of blades of each blade ring of each stage (22, 32, 42, 52) is illustrated in FIG. 1 along with its respective hub (23, 33, 43, 53). The blade rings (which are each comprised of a plurality of blades and hubs) rotate about rotor axis 1.1. Also illustrated for completeness are the stationary guide vanes 24 between each stage. An inner radius Ri of the each hub of stage (i) is illustrated for stages 1-4 and identified as R₁, R₂, R₃ and R₄. In this regard Ri extends from the axis 1.1 to the base hub surface on which the blade rests. In this respect, Ri is to be defined as the average radius to account for the possibility that the hub is not flat, but angled or contoured relative to the axis 1.1. As can be readily seen from FIG. 1, the radius Ri increases and then decreases, such that R₁<R₂, R₂>R₃, and R₃>R₄. Further it can be seen as R decreases, the length of the blades increases.

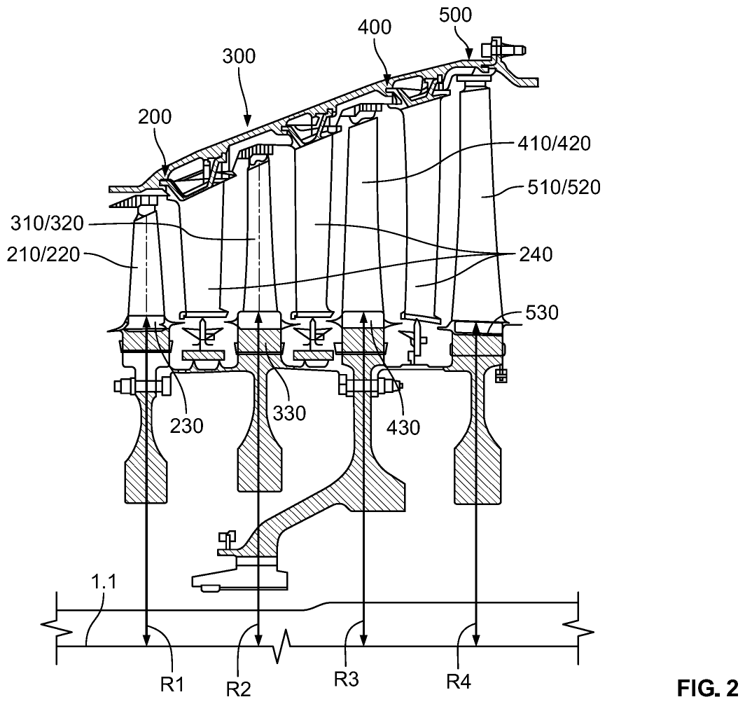

FIG. 2 shows an embodiment in accordance with the present invention. FIG. 2 shows a four stage low pressure turbine module, including four stages 200, 300, 400, 500 each having a bade ring (210, 310, 410, 510). Each blade ring includes a plurality of blades mounted on respective hubs. One of the plurality of blades of each blade ring of each stage (220, 320, 420, 520) is illustrated in FIG. 2 along with its respective hub (230, 330, 430, 530). Also illustrated for completeness are the stationary guide vanes 240 between each stage. The blade rings (which are each comprised of a plurality of blades and hubs) rotate about rotor axis 1.1. An inner radius Ri of the each hub of stage (i) is illustrated for stages 1-4 and identified as R₁, R₂, R₃ and R₄. In this regard Rᵢ extends from the axis 1.1 to the base hub surface on which the blade rests. In this respect, Rᵢ is to be defined as the average radius to account for the possibility that the hub is not flat, but angled or contoured relative to the axis 1.1. As can be readily seen from FIG. 2, the radius Rᵢ remains flat as contrasted with prior art FIG. 1, and the length of the blades for R₃ and R₄ are shorter in FIG. 2 as compared to prior art FIG. 1. In each stage (i) of the turbine module, the inner radius Rᵢ of the hub has a maximum deviation of +1.5% (to the top) and −3% (to the bottom) as compared to an average of the inner radii (R₁+R₂+R₃+R₄/4) of the inner blade platforms of the four stages of the LPT module.

Preferably, in each hub, all radii at the base hub surface (for example, the groove base) are identical within a tolerance of +/−5%.

Preferably, the flat hub contour of the present invention is provided in connection with a turbofan engine with a low-pressure turbine module which has no more than 4 stages, and which includes a fan which is coupled to the low-pressure turbine module via a gearbox. Preferably, the geared turbofan engine has a maximum thrust of at least 70 kN and at most 300 kN (or at most 170 kN, 200 kN or 250 kN), and wherein the low-pressure turbine module has a ratio of annulus area exit to annulus area inlet, Aₒᵤₜ/Aᵢₙ, of at least 2.2 and at most 3.3. The geared turbofan engine preferably has a bypass ratio that is at least 12:1 and at most 15:1. 16. The geared turbofan engine may have a low-pressure turbine rotational speed that is at least 6,500 rpm and at most 14,500 rpm. Further, in operation, the fan may rotate with a maximum thrust between 70 kN and 300 kN, and the low-pressure turbine module may rotate at a rotational speed of 6,500 to 14.500 rpm.

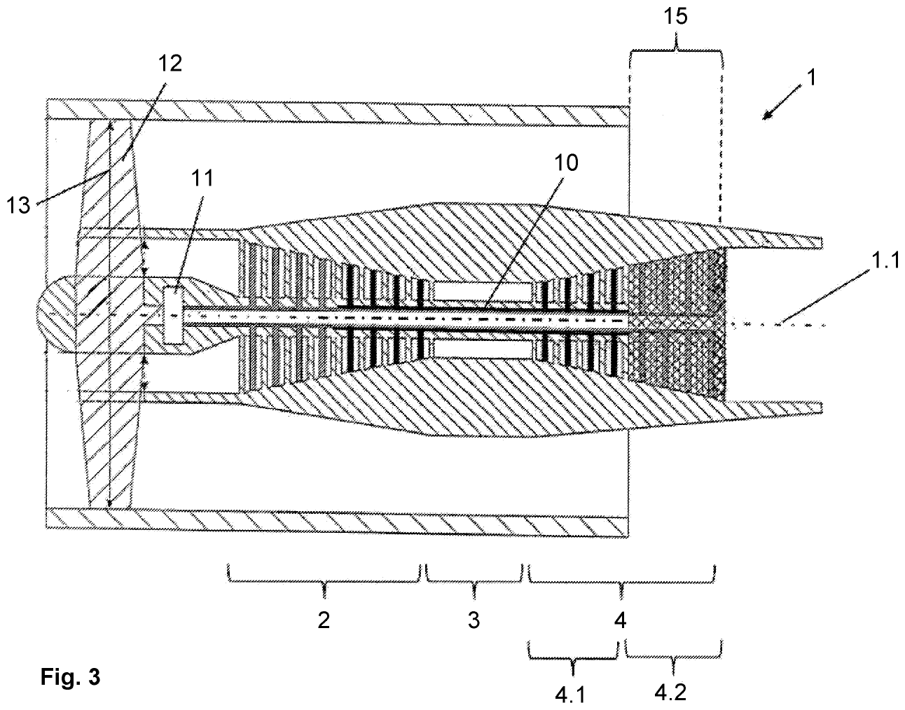

FIG. 3 shows such a turbofan engine 1 in a schematic axial section, i.e. viewed in a sectional plane containing its longitudinal axis 1.1, and as described in co-pending DE 102022133702 A1, which is hereby incorporated by reference in its entirety. The turbofan engine may be implemented in a regional, short-haul, or medium-haul aircraft, for example.

Functionally, turbofan engine 1 is divided into compressor 2, combustion chamber 3 and turbine 4, the latter having a high-pressure turbine module 4.1 and a low-pressure turbine module 4.2. During operation, air sucked in is compressed in the compressor 2, burned in the downstream combustion chamber 3 with added fuel, and the resulting hot gas is then expanded in the turbine 4.

The high-pressure and low-pressure turbine modules 4.1, 4.2 are each constructed in multiple stages, i.e. each have a plurality of guide vanes and rotor blade rings in axial succession. The latter are made to rotate about the longitudinal axis 2 with the expanding hot gas, with this kinetic energy also being used proportionately to drive the compressor 2. A shaft 10, on which the rotating blade rings of the low-pressure turbine module 4.2 rotate, is coupled via a transmission 11 to a fan 12 of the turbofan engine 1, so the fan 12 is also driven proportionately with the kinetic energy obtained.

A diameter 13 of the fan 12 may for example, be at least 204 cm and at most 247 cm, or at most 219 cm. The low-pressure turbine module 4.2, which has 3 or 4 stages, may have an axial length 15 of at least 20 cm and at most 32 cm, in particular at most 22 cm. The area ratio Aₒᵤₜ/Aᵢₙ of the low-pressure turbine module 4.2 may be at least 2.2 and at most 3.3, or is at least 2.2 and at most 2.4, and overall an expansion ratio greater than 8 may be realized with the low-pressure turbine module 4.2.

Preferably, the low-pressure turbine has 2, 3, or 4 stages.

The 3-stage low-pressure turbine module may have three rotor blade rings and two or three guide vane rings, with the last (most downstream) ring always being a rotor blade ring. The axial length of a corresponding low-pressure turbine module can, for example, be a maximum of 29 cm (with a possible lower limit of at least 20 cm).

The 4-stage low-pressure turbine module can have four rotor blade rings and three or four guide vane rings, the last ring always being a rotor blade ring. Such a low-pressure turbine module can in particular have an axial length of at most 32 cm (with a possible lower limit of at least 25 cm).

The turbofan engine as a whole can be designed in particular for a thrust range of 110 kN to 140 kN, with the low-pressure turbine module speed (redline) then being between 10,000 and 11,500 rpm.

In accordance with further embodiment s of the present invention, the Rᵢₙₙₑᵣ at the fourth stage is smaller than the Rᵢₙₙₑᵣ of stages 1-3, while still satisfying a maximum deviation of +1.5% (to the top) and −3% (to the bottom) as compared to each other stage. This is shown in FIG. 2. This arrangement provides an advantage in that the inlet Mach number at the last stage is lowered, resulting in improved efficiency

It should also be appreciated that the exemplary embodiments are only examples, and are not intended to limit the scope, applicability, or configuration in any way. Rather, the foregoing detailed description provides those skilled in the art with a convenient road map for implementing at least one exemplary embodiment, it being understood that various changes may be made in the function and arrangement of elements described without departing from the scope of protection as is derived from the claims and the combinations of features equivalent thereto.

What is claimed is:

1. A geared turbofan engine, comprising
a turbine module including a plurality of turbine stages, wherein for each stage (i) of the turbine module, an inner radius Rᵢ has a maximum deviation between +1.5% and −3% as compared to the average inner radius of the inner blade platforms of the plurality of stages;
a fan, the fan coupled to the turbine stages via a gear.

2. The geared turbofan engine of claim 1, wherein the turbine module is a low-pressure turbine module, and the geared turbofan engine is an aircraft engine.

3. The geared turbofan engine of claim 2, wherein the low-pressure turbine module has a ratio of an annulus space surface on an outlet side to an annulus space surface on an inlet side, Aₒᵤₜ/Aᵢₙ, of at least 2.2 and at most 3.3.

4. The geared turbofan engine of claim 2, having a maximum thrust of at least 70 kN and at most 300 kN.

5. The geared turbofan engine of claim 2, having a maximum thrust of at least 70 kN and at most 250 kN.

6. The geared turbofan engine of claim 2, having a maximum thrust of at least 70 kN and at most 200 kN.

7. The geared turbofan engine of claim 2, having a maximum thrust of at least 70 kN and at most 170 kN.

8. The geared turbofan engine of claim 2, wherein the fan has a diameter of at least 204 cm and at most 247 cm.

9. The geared turbofan engine of claim 2, wherein the fan has a diameter of at least 204 cm and at most 219 cm.

10. The geared turbofan engine of claim 2, wherein the low-pressure turbine has an axial length of at least 20 cm and at most 32 cm.

12. The geared turbofan engine of claim 3 wherein the plurality of stages consist of 3-stages, and the ratio Aₒᵤₜ/Aᵢₙ of the low-pressure turbine module is at least 2.3 and at most 2.7.

13. The geared turbofan engine of claim 3 wherein the plurality of stages consist of 3-stages, and the ratio Aₒᵤₜ/Aᵢₙ of the low-pressure turbine module is at least 2.2 and at most 2.4.

14. The geared turbofan engine of claim 3, wherein the plurality of stages consist of 4-stages, and the ratio Aₒᵤₜ/Aᵢₙ of the low-pressure turbine module is at least 2.5 and at most 3.3.

15. The geared turbofan engine of claim 2, having a bypass ratio that is at least 12:1 and at most 15:1.

16. The geared turbofan engine of claim 2, having a low-pressure turbine module rotational speed that is at least 6,500 rpm and at most 14,500 rpm.

17. A regional, short-haul, or medium-haul aircraft that includes the geared turbofan of claim 1.

18. A method of operating the geared turbofan of claim 2, wherein the fan rotates with a maximum thrust between 70 kN and 300 kN, and the low-pressure turbine module rotates at a rotational speed of 6,500 to 14.500 rpm.
